(19) United States
(12) Patent Application Publication
(10) Pub. No.: US 2005/0164709 A1
(43) Pub. Date: Jul. 28, 2005

(54) Method and apparatus for congestion control in high speed wireless packet data networks

(76) Inventors: Srinivasan Balasubramanian, San Diego, CA (US); Rath Vannithamby, San Diego, CA (US); Young C. Yoon, San Diego, CA (US)

Correspondence Address: COATS & BENNETT, PLLC, P O BOX 5, RALEIGH, NC, 27602, US

(21) Appl. No.: 10/954,515

(22) Filed: Sep. 30, 2004

Related U.S. Application Data
(60) Provisional application No. 60/507,417, filed on Sep. 30, 2003.
(60) Provisional application No. 60/527,846, filed on Dec. 8, 2003.
(60) Provisional application No. 60/530,859, filed on Dec. 17, 2003.

(51) Int. Cl. H04M 1/00

(52) U.S. Cl. 455/453

(57) ABSTRACT

A wireless communication network includes a base station system that transmits sector congestion information to influence mobile station sector selection processing. In an exemplary embodiment, where at least some of the mobile stations being supported by the network autonomously select the network sector from which they wish to receive forward link packet data transmissions, an exemplary base station influences that sector selection processing by transmitting congestion information on a per sector basis. Complementing that transmission by the network, an exemplary mobile station incorporates consideration of the sector congestion information into its autonomous sector selection processing logic. Thus, where potentially large numbers of mobile stations individually select the “best” sector from a candidate set of sectors, the network can perform load balancing by advertising sector congestion levels, so that mobile stations can choose (or avoid choosing) a given sector based at least in part of the congestion information.

### RELATED APPLICATIONS

This application claims priority under 35 U.S.C. § 119(e) from the following U.S. provisional applications: Application Ser. No. 60/507,417 filed on 30 Sep. 2003, Application Ser. No. 60/527,846 filed on 8 Dec. 2003, and Application Ser. No. 60/530,859 filed on 17 Dec. 2003. These applications are expressly incorporated in their entireties by reference herein.

### BACKGROUND OF THE INVENTION

The present invention generally relates to wireless communication networks, and particularly relates to facilitating autonomous sector selection by mobile stations operating in such networks.

Wireless communication networks based on the IS-2000 family of standards make use of a shared packet data channel to provide forward link packet data services at high rates to a plurality of mobile stations. Generally, the packet data channel transmitted in each sector carries data for each of the mobile stations being served by that sector, and the data rates used to serve each mobile station typically are a function of the reserve power available for allocation to the shared packet data channel, and the mobile station's particular radio conditions. Other types of networks offer similar shared channels supporting high-rate services, such as the High Data Rate (HDR) Channel defined for 1xEV-DO based systems—see the IS-856 standards—and the High Speed Downlink Packet Access (HSPDA) channels defined by the Wideband CDMA (W-CDMA) standards.

One characteristic of high-rate service on these kinds of shared channels is that each mobile station autonomously selects the particular network sector to be used for serving it. By allowing autonomous serving sector selection, each mobile station can select the “best” one of the available sectors that are candidates for serving it on the shared channel. Mobile stations typically pick the best serving sector by comparing the signal strengths of pilot signals received from each sector in set of sectors that are candidates for serving the mobile station, e.g., an “active set” of network sectors, which may be designated or controlled by the network. By selecting the sector offering the highest received signal strength from the set of candidate sectors, the mobile station ostensibly positions itself to be served at the highest possible rates.

As the mobile station's reception conditions change, it can “move” to another sector by signaling its selection of another sector in the set as the new serving sector. While the mechanisms for doing so may vary by network type, IS-2000 networks use an exemplary mechanism for serving sector selection by individual mobile stations.

According to the IS-2000 method, each mobile station being served on the shared channel provides channel quality feedback to the network that is used to set the serving data rate for the mobile station. Typically, mobile stations engaged in packet data service on the shared packet data channel provide such feedback in the form of Channel Quality Indicator (CQI) reports sent every 1.25 ms (800 Hz). The mobile station “covers” its CQI reports with a (Walsh) coding corresponding to its current serving sector. When the mobile station wants to change to a new serving sector, it begins alternately covering its CQI reports with a (Walsh) coding corresponding to the target sector. Some time later, the mobile station switches over to the shared packet data channel of the target sector, which is now the new serving sector, and the network begins transmitting forward link data for the mobile station on the new serving sector's shared packet data channel.

Allowing mobile stations to select (and reselect) serving sectors dynamically in the above manner allows individual ones of the mobile stations to pick the sectors offering them the best signal quality. However, simply picking the sector corresponding to the best received signal quality at the mobile station does not necessarily ensure that the mobile station gets the best possible shared channel service because the rate at which the mobile station is served on a given sector's shared channel depends on a number of factors, such as the sector's congestion level. That is, a highly congested sector may not serve the mobile station at as high a rate as a less congested sector, even though it can provide a stronger received signal at the mobile station.

Further, since the shared channel users (mobile stations) change serving sector selections autonomously, the conventional network has no mechanism to “shed” shared channel users from a congested sector, or any mechanism to prevent additional shared channel users from selecting an already overcrowded sector. Consequently, the conventional network is left without any direct ability to perform “load balancing” wherein the shared channel users are steered away from the more congested network sectors, and toward the less congested sectors.

### SUMMARY OF THE INVENTION

The present invention comprises a method and apparatus enabling a wireless communication network to influence the autonomous sector selection operations of mobile stations being supported by the network. More particularly, the network transmits sector congestion information to influence sector selection by the mobile stations. With the network providing sector congestion information, the mobile stations can incorporate that information into their sector selection decision logic. A mobile station thus may avoid selecting a heavily congested sector, or may select a less-congested sector as its new serving sector. Of course, the selection processing embodied in the mobile stations can be quite sophisticated, and may, for example, be based on comparing combinations of sector signal qualities and sector congestion level values between candidate sectors. Additionally, or alternatively, the mobile stations may use one or more defined probability values to control the probability of changing to a better sector. Such probability information can be sent to the mobile stations in the form of probability tables, for example, that can be used to set the probability of sector reselection.

From the network's perspective, an exemplary method of providing mobile stations with sector congestion information comprises determining sector congestion information for each of one or more sectors providing a forward link packet data service that is autonomously selectable by mobile stations, and transmitting the sector congestion information from each of the one or more sectors to facilitate sector selection by mobile stations engaged in the forward link packet data service. Generally, for each sector providing the packet data service, the network estimates at least one of a forward link congestion level value and a reverse link congestion level value. In this context, “congestion” may be based on, but is not limited to, any one or more of these items: forward link power and/or spreading code resources (total, or allotted for the packet data service), the number of voice and/or packet data users, the reverse link loading (e.g., rise-over-thermal), average sector throughput for the packet data service (forward and/or reverse link), quality-of-service (QoS) constraints.

Regardless of the particular conditions on which the current sector congestion level values are based, the network may transmit such congestion information to mobile stations on a periodic basis, and such transmission may be discontinuous in that no congestion information is transmitted for a given sector, if that sector's congestion levels are below a defined congestion threshold. In an exemplary IS-2000 embodiment, the packet data service of interest is provided by the Forward Packet Data Channel (F-PDCH), which is transmitted in each of a number of radio base station sectors in the network. The congestion information—e.g., sector congestion level value(s)—can be transmitted in each sector using a Forward Packet Data Control Channel (F-PDCCH).

In this context, the F-PDCCH transmitted in each sector may be modified to carry sector congestion information in the form of a Sector Loading Information Message (SLIM), which may be sent on a periodic basis, at least when the sector congestion level is above a given threshold. The SLIM may carry quantized congestion level values for one or both the forward and reverse link congestion levels. Other arrangements may be implemented in other network types—e.g., W-CDMA—according to the available channel definitions. An exemplary F-PDCCH modification comprises using an available (otherwise unused) Medium Access Control Identification value (i.e., a unique MAC ID) for transmission of the SLIMs.

Regardless, at a mobile station, an exemplary method of selecting a serving sector in a wireless communication network for packet data service comprises receiving sector congestion information for one or more sectors in a set of sectors that are serving sector candidates for the mobile station, and selecting a sector from the set as the serving sector based at least in part on the sector congestion information. Receiving sector congestion information may comprise receiving a control channel signal from each of one or more sectors that carries sector congestion information. Thus, each sector may transmit a forward link packet data control channel in conjunction with a forward link packet data channel that is selectable by mobile stations for forward link packet data service, and the mobile station may monitor the control channel in one or more sectors to be considered in its selection decision processing for the corresponding sector congestion information.

In that context, selecting a sector from the set as the serving sector based at least in part on the sector congestion information may comprise selecting or reselecting a serving sector from among the sectors in the set based on sector signal quality measurements and sector congestion level values. More particularly, the mobile station may change from a current serving sector to a new serving sector based on determining that the new serving sector has a better combination of sector signal quality and sector congestion. That determination may be based on weighting signal quality measurements for the current and new serving sectors by corresponding sector congestion level values, and comparing the weighted signal quality measurements. For example, the mobile station may determine whether a difference between the weighted signal quality measurements of the current and new serving sectors exceeds a defined threshold.

Thus, the threshold may be used to limit “ping-ponging” by the mobile station between sectors by requiring that, where another sector besides the current serving sector is a “better” serving sector candidate, the mobile station will not switch unless the other sector is better by at least the margin defined by the threshold. “Better” in this context depends on the particular evaluation method implemented in the mobile station, and may mean that a metric calculated for sector targeted as the new serving sector exceeds the same metric calculated for the current serving sector. An exemplary metric comprises a sector signal quality measurement divided by a sector congestion level value.

As mentioned earlier, the network may transmit forward and reverse link congestion information. Thus, a mobile station may receive reverse link congestion level values for one or more sectors, in addition to receiving forward link congestion level values for those sectors. The selection metric calculated by the mobile station therefore may be based on either the forward or reverse link congestion level values, or some combination of the two. Also, different metrics may be calculated and compared for forward and reverse links for the sectors under consideration. Thus, the mobile station's sector selection decision may be based on forward link congestion, reverse link congestion, or some combination of the two.

In one or more exemplary embodiments, the mobile station bases its selection decision on either forward or reverse link congestion level values, depending on whether its current service is more sensitive to forward or reverse link performance constraints. Thus, the mobile station requiring good reverse link performance may select a new serving sector that has a lower reverse link congestion, even if its forward link is more congested than that of the current serving sector.

Of course, other selection decision algorithms may be adopted as needed or desired, and it should be understood that the present invention is not limited to the above features and advantages. Indeed, those skilled in the art will recognize additional features and advantages upon reading the following detailed discussion, and upon viewing the accompanying figures.

### BRIEF DESCRIPTION OF THE DRAWINGS

FIG. 1 is a diagram of an exemplary wireless communication network according to one or more embodiments of the present invention.

FIG. 2 is a diagram of radio base station and base station controller circuit details for an exemplary base station system according to one or more embodiments of the present invention.

FIG. 3 is a diagram of exemplary network processing logic to implement the per-sector transmission of sector congestion information.

FIG. 4 is a diagram of exemplary mobile station processing logic to implement congestion-based sector selection.

FIG. 5 is a diagram of exemplary per-sector transmission of congestion information.

FIG. 6 is a diagram of mobile station circuit details for an exemplary mobile station according to one or more embodiments of the present invention.

FIG. 7 is a diagram of exemplary processing logic details for mobile station-based sector selection processing.

### DETAILED DESCRIPTION OF THE INVENTION

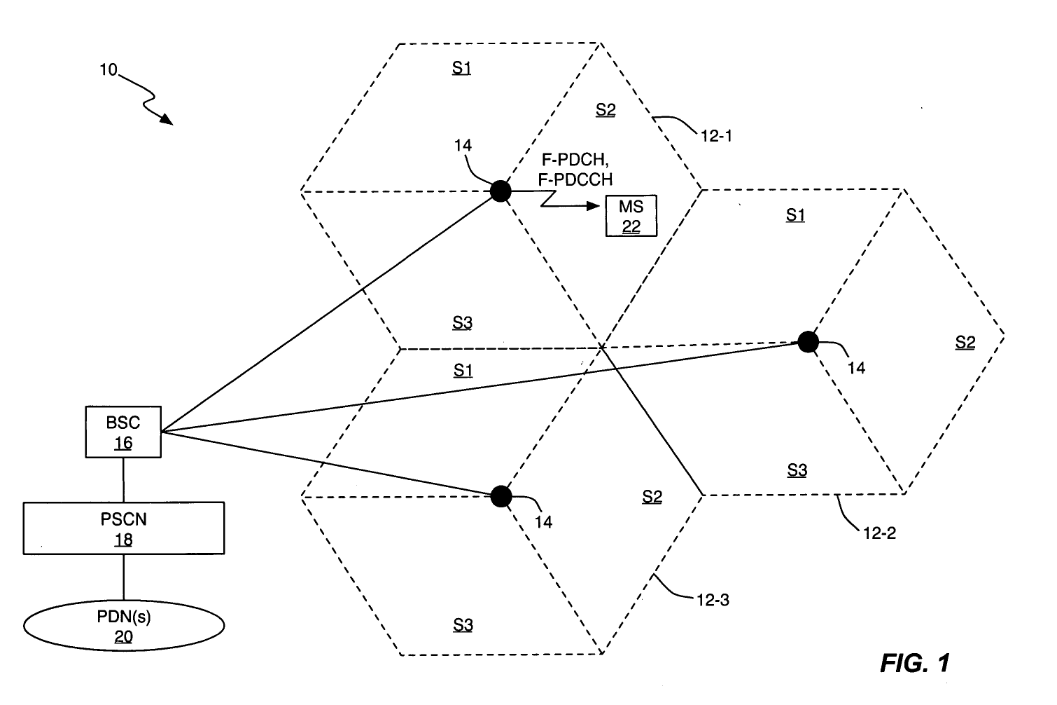

The present invention provides a method and apparatus to base mobile station sector selection operations at least in part on knowledge of sector congestion levels. An exemplary wireless communication network 10 is partially illustrated in FIG. 1. Network 10 may comprise, for example, a cellular communication network based on the IS-2000 standards, or based on the W-CDMA standards. As illustrated, network 10 comprises a Radio Access Network (RAN) including Radio Base Stations (RBSs) 14 and a Base Station Controller (BSC) 16, and a Packet Switched Core Network (PSCN) 18, which communicatively couples network 10 to one or more Public Data Networks (PDNs) 20—e.g., the Internet. Those skilled in the art will appreciate that network 10 may include additional entities that are not illustrated for clarity.

Network 10 provides radio coverage organized as a plurality of radio cells 12-1,12-2, and 12-3, with each cell providing three sectors S1, S2, and S3, of radio coverage. Note that for convenience of discussion, this disclosure focuses on “sectors” as the basic area of radio coverage, but those skilled in the art should appreciate that the same concepts can be applied at the per-cell level, etc. A mobile station 22 operating within the network's coverage area generally can receive signals from more than one sector, and the mobile station's return radio signals generally can be received by network 10 in more than one sector.

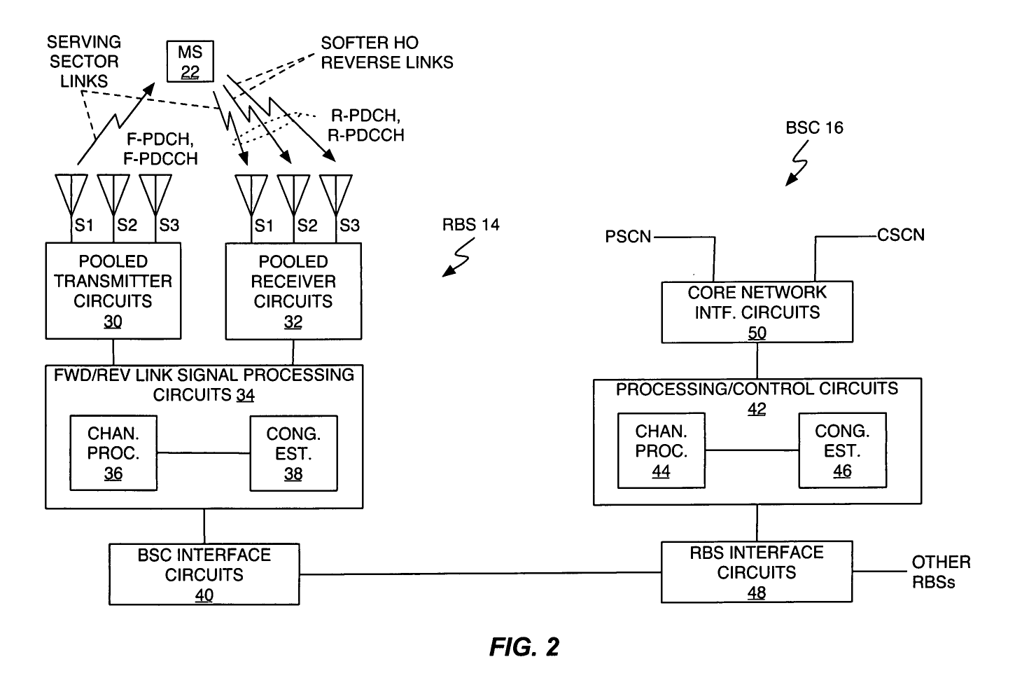

FIG. 2 illustrates an exemplary RBS 14 providing sectorized transmit and receive coverage supporting the above network implementation. The illustrated RBS 14 comprises pooled transmitter circuits 30, pooled receiver circuits 32 (i.e., transceiver circuit resources), forward/reverse link processing circuits 34, which include channel processing and congestion estimation circuits 36 and 38, respectively, and BSC interface circuits 40. The illustrated forward/reverse link signal processing circuits may comprise hardware, software, or any combination thereof. In an exemplary embodiment, at least some of the network-based sector congestion estimation and transmission processing is implemented as program instructions for execution by one or more microprocessors, or other logic processing circuits, implemented in RBS 14.

Thus, each RBS 14 may be configured to perform ongoing per-sector congestion processing to estimate the congestion level(s) of each radio sector, and be further configured to transmit such information on a per-sector basis. However, some or all of such processing may be performed at the BSC-level. Thus, FIG. 2 further illustrates an exemplary BSC 16 that includes circuit elements supporting the present invention. More particularly, BSC 16 comprises processing and control circuits 42, which include channel processing and congestion estimation circuits 44 and 46, respectively. The congestion estimation circuits 46 may be implemented in hardware, software, or some combination thereof, and may be configured to estimate per-sector congestion levels, and to initiate the transmission of that information by the RBSs 14. It should be understood that these circuit elements may be modified or omitted in dependence on how much congestion estimation processing is implemented at the RBS level.

Turning back to the RBS details of FIG. 2, one sees that RBS 14 transmits high-rate packet data to the mobile station 22 on the forward link from one sector—i.e., a current serving sector—but receives reverse link transmissions from the mobile station 22 at multiple sectors. In an IS-2000 based implementation, RBS 14 transmits forward link packet data to the mobile station on the F-PDCH and associated control information on the F-PDCCH from one “serving” sector at a time, and receives reverse link packet data on the mobile station's R-PDCH and associated control signaling on the mobile station's R-PDCCH at multiple sectors.

While the present invention generally leaves the mobile station 22 free to select the F-PDCH serving sector based on the mobile station's autonomous processing, that network influences that decision processing by providing the mobile station 22 with congestion information for one or more sectors. In an exemplary embodiment, the mobile station 22 is served on the F-PDCH from any one of the sectors in the mobile station's currently designated “active” set of sectors. While active set designation as performed by network 10 may vary depending on the wireless standard embodied by network 10, such active sets generally are based on identifying the RBS sectors capable of transmitting to the mobile station 22 at or above a defined signal strength.

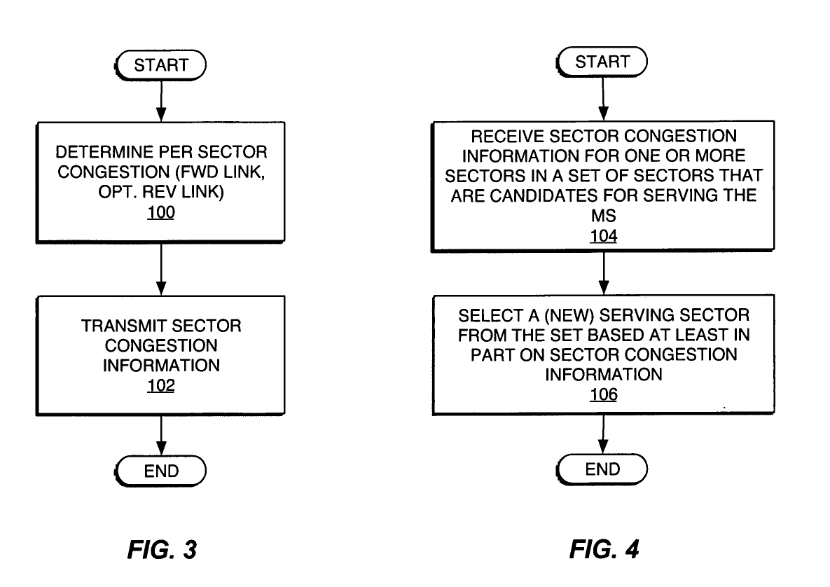

Regardless, assuming that a given mobile station 22 is being served by one sector in a set of sectors that are candidates for serving the mobile station 22, FIG. 3 broadly illustrates exemplary network processing in accordance with the present invention. According to the illustrated processing logic, the network 10 determines per sector congestion information (forward link and/or reverse link congestion estimates) (Step 100), and transmits such information in one or more of its sectors, for use by mobile stations 22 operating in those sectors, and/or considering one or more of those sectors as possible candidates for serving sector selection (Step 102).

FIG. 4 broadly illustrates complementary, exemplary mobile station processing, wherein the mobile station 22 receives sector congestion information for one or more of the network sectors that are candidates for serving the mobile station 22 (Step 104). The mobile station 22 may receiving information for all candidate sectors, e.g., all sectors in its active set, or from fewer than all such sectors. In any case, the mobile station 22 incorporates the sector congestion information into its sector selection processing by basing its sector selection decision at least in part on the sector congestion information (Step 106). By way of non-limiting example, the mobile station 22 may select a new serving sector responsive to receiving an indication that its current serving sector is congested, or it may avoid the selection of a new serving sector if the target sector is congested, or at least more congested than the current serving sector.

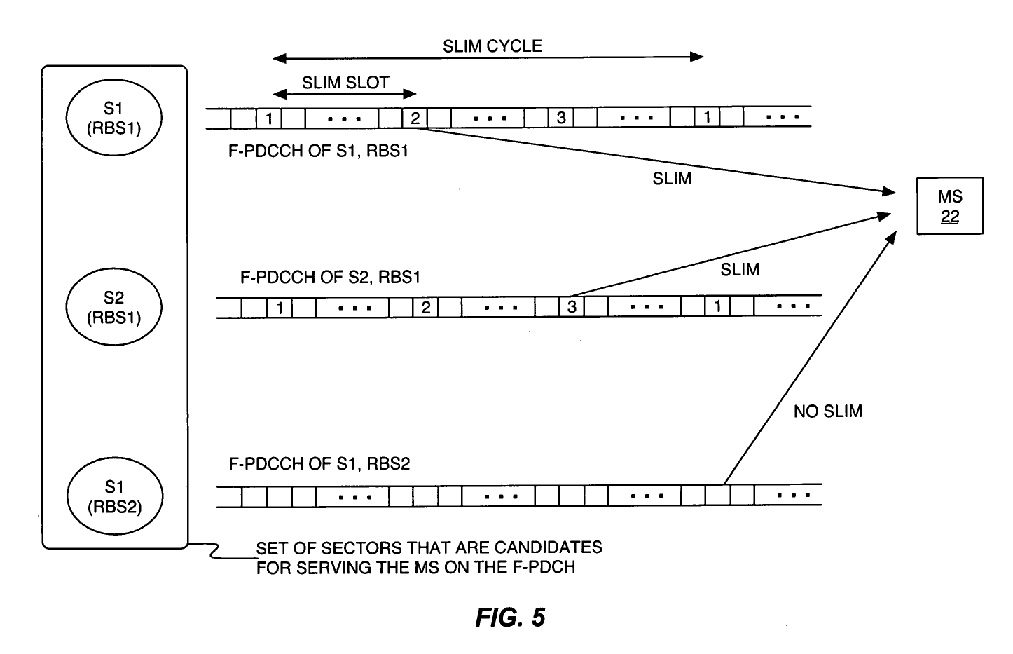

FIG. 5 illustrates an exemplary basis for communicating load (congestion) information to mobile stations 22. In an IS-2000 embodiment, each sector of RBSs 14 independently transmits its load information over the F-PDCCH being transmitted in that sector. The load information may be carried as a Sector Load Information Message (SLIM) repeated at designated slots within the F-PDCCH, such that the SLIM is broadcast to all users in the sector. (Here, the term “user” denotes those mobile stations 22 being served on the sector's F-PDCCH, or contemplating service thereon.)

The SLIM can be configured to carry information on both the forward link (FL) and reverse link (RL) loading, and can be transmitted in synchronous time slots, such that each sector provides SLIM information in coordinated fashion. Note that the SLIMs sent from the different sectors can be configured via Layer 3 (L3) signaling, and note that the same F-PDCCH slot can be used across sectors, or staggered slots can be used. The use of staggered message timing across sectors may reduce the time needed for a given mobile station to obtain the SLIM on one sector's F-PDCCH, and then obtain the SLIM for the same corresponding congestion measurement interval on another sector's F-PDCCH.

Thus, as shown in FIG. 5, each RBS 14 is configured to transmit SLIMS on the F-PDCCH in each RBS sector using a SLIM slot/cycle timing, and the same or different slot/cycle timing may be used across sectors. Further, RBSs 14 may be configured to not consume time sending SLIMs on a given sector's F-PDCCH, unless the congestion level(s) in that sector have meet or exceed one or more defined congestion thresholds. In other words, the RBSs 14 can be configured not to send congestion information unless sector congestion is high as determined by one or more measurement references. With this approach, the absence of SLIMs on a given sector's F-PDCCH implicitly indicates low congestion levels in the sector.

In more detail, in the context of one embodiment, the mobile station 22 is configured to switch serving sectors based on measuring signal qualities of the sectors in its active set, and on load information received for those sectors. Typically, this requires the mobile station 22 to acquire congestion information for the current serving sector and at least for the next “best” sector, which may be identified as the candidate sector other than the serving sector having the best signal quality measurement (e.g., the one that provides the highest Carrier-to-Interference (C/I) ratio at the mobile station 22. To acquire such congestion information from multiple sectors, the mobile station may implement more than one radio frequency (RF) receiver chain—e.g., it may implement receive chains for the F-PDCCH signal from each one of two or more sectors. In thinking back to FIG. 5, one sees that such information can be obtained simultaneously if all sectors transmit congestion information at the same time. Of course, the same RF receive chain can be used to obtain congestion information from one sector's F-PDCCH, and then successively reconfigured to decode the F-PDCCHs of one or more additional sectors, one at a time.

If RBSs 14 are configured always to transmit SLIMS on the F-PDCCH in each sector, even when an individual sector is only lightly loaded, the mobile station 22 can use such information to perform sector selection on a continuous basis, using measured signal qualities and received congestion information for each sector in its active set. The overall effect of mobile stations 22 performing congestion-based sector selection is that of “load balancing” from the network's perspective. That is, with relative levels sector congestion incorporated into the selection processing logic of the mobile stations 22, the overall effect is for mobile stations 22 to prefer less congested sectors over more congested sectors when making their selection decisions. Thus, network 10 indirectly pushes the users of its high-rate data services toward its less congested sectors, without interfering with the autonomous sector selection operations of those users.

However, as noted above, rather than always transmitting SLIMs in a given sector, RBSs 14 may be configured such that the processing logic controlling transmissions in each sector independently decides whether to transmit SLIMs on the F-PDCCH based on determining whether or not the sector has become congested. If the sector is congested, SLIMs are transmitted on that sector's F-PDCCH, but otherwise are not transmitted to thereby leave all of the available F-PDCCH time available for packet data service control. Thus, a mobile station 22 currently being served on the F-PDCH of a sector that is not transmitting SLIMs on the associated F-PDCCH may remain there, assuming that the sector offers the best signal quality. However, once that sector begins transmitting SLIMs, the mobile station 22 would obtain congestion information from one or more other candidate sectors to determine whether it should select a new serving sector. Note that the mobile station 22 may be configured to use a default congestion level value (or default values) in its sector selection decision processing for any sector for which it has not received current loading information.

Whether received on the F-PDCCH, or obtained from default values, such loading information may express the level of sector congestion levels according to various formats, and can be based on any number of congestion-related variables, or combinations of variables. For example, an exemplary SLIM transmission on the F-PDCCH can be identified as a SLIM based on a characteristic MAC ID value, or some other SLIM identifier. For example, if the F-PDCCH0 message contains a MAC_ID equal to ‘00000001’, this would indicate that the F-PDCCH0 message contains a SLIM rather than a forward packet data channel assignment for a specific mobile station. The remaining bits in the message would comprise a bitmap corresponding to forward and/or reverse link loading levels within the sector. All mobile stations that receive this message can save the bitmap for subsequent sector switching determinations. Each base station uses such a message to provide mobile stations with current sector loading information for the forward and/or reverse links.

Thus, each SLIM may carry either or both forward and reverse link congestion level values, and those values may be formed as multi-bit congestion level (or magnitude) indicators. By way of non-limiting example, the forward link sector congestion level value in each SLIM may be represented by an n-bit value (e.g., 8 bits), and the reverse link congestion may be represented by a m-bit value (e.g., 5 bits). Fewer or greater numbers of bits may be used depending upon the desired resolution for conveying sector congestion levels. Further, sub-bit groupings within the bits allocated for the forward or reverse link congestion level values may be defined to convey more than one congestion parameter.

The congestion parameter (or parameters) represented in the SLIM can include, but are not limited to, the number of shared packet data channel users in the sector and/or the number of voice or dedicated channel users in the sector, the amount of forward link transmit power available in the sector for the shared channel, the number of spreading code resources available overall or for the shared channel, the average aggregate sector throughput for the forward and/or reverse links, the quality-of-service constraints existent in the sector, the sector's reverse link receiver's rise-over-thermal (noise) estimate, etc. Of course any number of additional or alternative measurements, estimations, etc., that in any way convey the sector's loading conditions may be used.

In general, the loading information conveyed by the SLIMs should provide mobile stations 22 with a basis for determining whether a given sector offers the same or better packet data service as its currently selected serving sector in consideration of the relative signal quality measurements for the sectors. As such, it should be understood that the present invention is not limited to any particular congestion parameters estimations or measurements at the RBSs 14 (or at BSC 16) for generation of the sector congestion information to be transmitted.

In terms of providing for the transmission of sector congestion information, an exemplary set of parameters to be communicated by the RBSs 14 to the mobile station 22 include these items: (1) LOAD_REPORTING_MODE—specifies the BS operating mode of reporting the sector level load information to the mobile stations and includes the values (A) NONE, (B) CONGESTION_BASED, (C) ALWAYS_ON; (2) SLIM_SLOT_LENGTH—a 4-bit field is specified when operating in Modes (B) and (C) of Item (1), and provides the length in units of 20 msecs (note that the SLIM is carried in the first 1.25 msecs slot in the specified interval); (3) SLIM_CYCLE_LENGTH—an 8-bit field is specified when operating in Modes (B) and (C) of Item (1), and it satisfies the equation SLIM Slot Length*SLIM Cycle Length*N=1.28 seconds for some integer value of N; (4) CDM Congestion Parameters—includes the values (A) C/I_SCHEDULING_THRESHOLD—specified when operating in the CDM mode, provides the C/I value above which the mobile station is required to remain in the current serving sector for possible scheduling, and (B) C/I_REPORTING_DISTANCE—a 4-bit field specifies the distance in units of 1.25 msec slots from the slot the mobile station sends the C/I report to the slot where it is used by the Base Station and mobile station for performing the comparison. Note that all of the above parameters can be transmitted to the mobile station 22 using the System Parameter Message/Extended Channel Assignment Message, as defined by the IS-2000 standards. Additional or alternative messages for conveying such information include the Universal Handoff Direction Message (UHDM), the Service Connect Message (SCM), and the In Traffic System Parameter Message (ITSPM). Other network standards provide similar mechanisms for conveying such information to mobile stations.

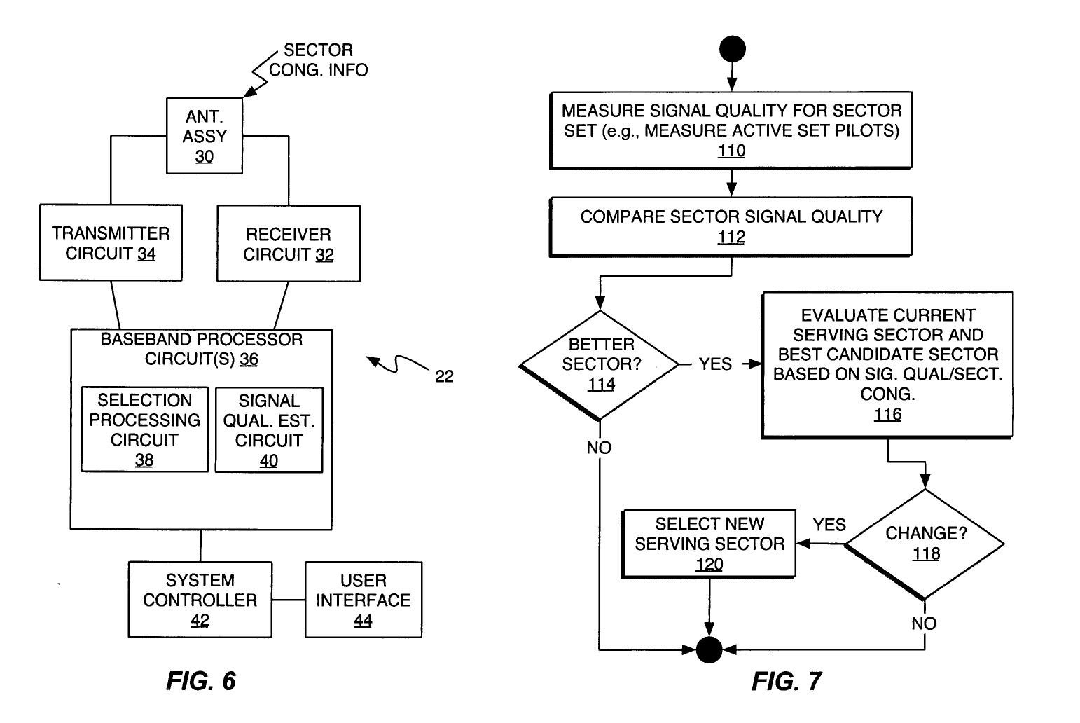

Before detailing exemplary methods for processing the transmitted information at the mobiles stations, FIG. 6 illustrates an exemplary mobile station 22 according to one or more embodiments of the present invention. The illustrated mobile station comprises an antenna assembly 30, RF receiver and transmitter circuits 32 and 34, respectively, baseband processing circuit(s) 36, which includes or is associated with a sector selection processing circuit 38 and a signal quality estimation circuit 40, a system controller 42, and a user interface 44. Those skilled in the art will appreciate that mobile station 22 may comprise a cellular radiotelephone, a wireless pager, a Portable Digital Assistant, a laptop/palmtop computer with wireless communication capability, or essentially any other type of portable communication device, and that its particular arrangement of circuits and features will depend on its particular use or purpose.

Further, those skilled in the art should appreciate that the illustrated circuits may comprise hardware, software, or any combination thereof. For example, the selection processing circuit 38 may be a separate hardware circuit, or may be included as part of other processing hardware. More advantageously, however, the selection processing circuit is at least partially implemented via stored program instructions for execution by one or more microprocessors, Digital Signal Processors (DSPs), or other digital processing circuit included in mobile station 22.

In any case, FIG. 7 illustrates one embodiment for sector selection processing at the mobile station 22, wherein processing begins with the mobile station 22 making signal quality measurements for one or more sectors in the set of sectors that are candidates for serving it on the F-PDCH (or on some other high-rate data channel) (Step 110). In an exemplary embodiment, this operation comprises estimating C/I ratios for the active set pilots being transmitted by the sectorized RBS transmitters in one or more RBSs 14. It should be understood that such measurements may be made on an ongoing basis according to a defined schedule, as needed, or according to some other algorithm.

With updated signal quality measurements thus available, the mobile station 22 then compares the measured signal qualities (Step 112), and determines whether any sector in the set has a better signal quality than the sector currently selected by the mobile station as the serving sector (Step 114). If so, mobile station 22 evaluates the current serving sector and the target serving sector—i.e., the other sector having a higher signal quality—based on the signal qualities and the sector congestion levels of the two sectors (Step 116). If that evaluation indicates that the target sector would be a better serving sector (Step 118), then mobile station 22 selects the target sector as its new serving sector and changes to it according to a defined reselection procedure (Step 120). IS-2000 provides a mechanism for the mobile station 22 to signal sector changes to the network 10 using encoded CQI reports, as explained earlier herein.

In the above processing, mobile station 22 may be configured to implement an evaluation method that uses some combination of per sector signal quality measurements and per congestion level values to determine whether another one of the available candidate sectors would offer better service than the currently selected serving sector. For example, if the current serving sector has the highest signal quality, it still may not offer as good a data rate as another candidate sector that has a slightly lower signal quality but is less congested. Thus, for roughly comparable signal qualities, the relative congestion levels may determine which sector is actually the better choice as the mobile station's serving sector.

In particular, in an exemplary approach to sector selection, the mobile station 22 forms weighted signal quality measurements, wherein it weights the signal quality measurement of the current serving sector according to that sector's congestion information, and weights the signal quality measurement for at least one target sector that is a candidate for selection as a new serving sector according to the target sector's congestion information. Mobile station 22 then determines whether to change sectors by comparing the weighted measurements. The comparison can be simple, wherein a “greater than” test is used. That is, if the weighted measurement of the target sector exceeds the weighted measurement of the current serving sector, the mobile station 22 changes to the target sector—i.e., signals the network 10 that it is selecting the target sector as its new serving sector.

However, the selection process can be made more sophisticated. For example, effective load balancing by the network 10 is facilitated by at least some of the mobile stations 22 engaged in high-rate packet data services moving to less congested sectors, but not all such mobile stations 22 in a given sector necessarily should select new serving sectors responsive to that sector becoming congested, because that would leave the sector underutilized. Thus, the mobile station 22 may be configured to change sectors according to a defined probability value. According to this method, the mobile station 22 would determine that a better sector is available in terms of relative congestion levels, but would change to that sector according to a defined probability value.

In implementing this method, the network 10 may transmit one or more probability values to the mobile station 22 for use in sector selection processing, and different probability values may be used depending on the relative differences between the signal qualities and congestion levels of the sectors being evaluated. Thus, if another sector was much better than the current serving sector, the mobile station 22 would change sectors with a higher probability than if the other sector was only slightly better.

Even if mobile station 22 does not use probability-based changeover, the sector selection processing can be qualified by using a simple threshold value. For example, for whatever metric the mobile station 22 uses to compare sectors—e.g., the weighted signal quality described above—it can calculate a difference between the metrics of its current serving sector and the target sector, and compare that difference to a defined threshold. If the difference exceeded the threshold, the mobile station 22 would select the target sector as its new serving sector. Obviously, adjusting, or otherwise setting, the threshold determines how aggressively the mobile station 22 performs sector reselection.

In more detail, let α₀ denote the Forward Link (FL) loading on the current serving sector of the mobile station 22 and let α_{φ} denote the FL loading for all other base station sectors in the mobile station's active set. If α_{φ} is not reported for a particular base station sector, then the mobile station 22 assumes some default value, which it may be configured with, or which may be received from network 10. Let Γ₀ denote the C/I of the FL for the serving sector and Γ_{φ} denote the C/I for the FLs of the other base station sectors in the mobile station's active set. Further, assuming that Reverse Link (RL) loading information is provided, let β₀ denote the RL loading on the serving sector of the mobile station 22 and let β_{φ} denote the RL loading for all other base station sectors in the mobile station's active set. If β_{φ} is not reported for a particular base station sector, then the mobile station 22 assumes some default value.

As its basis for serving sector selection, mobile station 22 determines the base station sector for which the ratio Γ_{φ}/α_{φ} is a maximum, subject to acceptable values of Γ_{φ}/β_{φ}. (That latter qualification avoids sectors where the RL is too heavily loaded, or where the disparity between RL and FL loading is too high.) If Γ_{φ}/α_{φ} is greater than Γ₀/α₀ by at least some specified quantity ε_{FL}, and if Γ_{φ}/β_{φ} is greater than Γ₀/β₀ by at least some specified quantity ε_{RL}, then the ratios of C/I-to-FL congestion and C/I-to-RL congestion are more favorable in another sector, and the mobile station 22 switches to that other sector. Generally, ε_{FL} will be a positive value and ε_{RL} can take a positive or negative values. The significance of allowing negative values for the reverse link is that the mobile station is permitted to switch to a sector with a worse C/I-to-RL congestion level value that its current serving sector. Thus, the switchover decision in such instances is biased toward finding the sector with a better C/I-to-FL congestion level value than the current serving sector.

Of course, the present invention contemplates changing such logic, so that negative values are permitted for the forward link, i.e., ε_{FL} can be negative. Indeed, the mobile station 22 may dynamically change its evaluation algorithm depending on whether forward link or reverse link performance is more important given its current data service requirements. For example, some types of data services place more stringent QoS constraints on the RL rather than the FL, or vice versa. In the first instance, the mobile station 22 can bias its sector selection to find the best RL conditions among the candidate set of sectors, and in the second instance, it can bias its sector selection processing to find the best FL conditions.

Of course, many opportunities are available for tailoring the present invention, such that it strikes a desired balance between increased selection processing complexity and performance overhead. For example, the mobile station 22 may be configured not to use congestion-based selection processing if the C/I ratio of its current serving sector is above a defined threshold. Also, mobile station 22 can be configured to limit its reception of congestion information to the currently selected serving sector and the next-best serving sector candidate in terms of C/I ratios. Accordingly, the mobile station 22 is required to “tune” to the F-PDCCH of only one extra sector, rather than to spend additional time monitoring the F-PDCCHs of all sectors in its active set.

Regardless of these additional selection processing enhancements, the underlying point is that network 10 provides mobile station 22 with per sector congestion information that is incorporated into the mobile station's sector selection processing logic, and can therefore influence sector selection by mobile station 22 as a function of sector congestion levels. Additionally, the present invention enables the network to remove a given sector from selection consideration by the mobile station 22 for a temporary period of time. Thus, rather than being forced to remove a given sector from the mobile station's active set to avoid the possibility of the mobile station 22 selecting that sector for packet data service, network 10 sends a message to mobile station 22 indicating that one or more of its active set sectors should be excluded from sector selection processing for a temporary period.

This method is useful, for example, where the mobile station 22 has just moved from a heavily congested sector to a new sector, and the network wants temporarily to remove the previous serving sector from consideration, i.e., to delay any switchback by the mobile station to the previous serving sector. Further, it provides a mechanism whereby the network 10 can designate a given sector as temporarily “off-limits” to mobile stations 22 that otherwise would consider it as a prospective candidate for sector selection. The message can carry a quantized delay value indicating to the mobile station 22 how long it should exclude the given sector from selection consideration. Advantageously, the message can be defined such that a zero delay value (or some other characteristic) value can be used to indicate that the mobile station 22 should permanently remove the indicated sector from selection consideration. Of course, the indicated sector could be restored to the mobile station's active set at a later time via the appropriate L3 signaling.

Effectively, the method above equates to using a configurable timer whereby a given sector is removed from the set available for serving sector consideration by the mobile station 22 until expiration of that timer. Alternatively, or additionally, similar timing mechanisms can be used to control the frequency at which the mobile station 22 undertakes new serving sector selection processing subsequent to changing sectors, to limit ping-ponging between sectors, for example.

In any case, the present invention, as illustrated by the above exemplary embodiments, comprises a method and apparatus providing continuous load balancing in a wireless communication network by enabling mobile stations desiring high-rate packet data services to select the best sector for that service in consideration of relative sector signal qualities and congestion levels. By influencing the autonomous sector selection processing of mobile stations as a function of per-sector congestion levels, the network relieves localized congestion problems that might otherwise develop. It should be understood, then, that the present invention is not limited by the foregoing discussion, but rather by the following claims and their reasonable legal equivalents.

1. At a mobile station, a method of selecting a serving sector in a wireless communication network for packet data service comprising:
receiving sector congestion information for one or more sectors in a set of sectors that are serving sector candidates for the mobile station; and
selecting a sector from the set as the serving sector based at least in part on the sector congestion information.

2. The method of claim 1, wherein receiving sector congestion information for one or more sectors in the set of sectors comprises receiving a control channel signal from each of one or more sectors that carries sector congestion information.

3. The method of claim 1, wherein each sector in the set transmits a forward link packet data control channel, and wherein receiving sector congestion information for a given one of the sectors in the set comprises receiving sector congestion information via the forward link packet data control channel.

4. The method of claim 1, wherein selecting a sector from the set as the serving sector based at least in part on the sector congestion information comprises selecting or reselecting a serving sector from among the sectors in the set based on sector signal quality measurements and sector congestion level values comprising the sector congestion information.

5. The method of claim 1, wherein selecting a sector from the set as the serving sector based at least in part on the sector congestion information comprises changing from a current serving sector to a new serving sector based on determining that the new serving sector has a better combination of sector signal quality and sector congestion level.

6. The method of claim 1, wherein selecting a sector from the set as the serving sector based at least in part on the sector congestion information comprises selectively changing from a current serving sector to a new serving sector based on weighting signal quality measurements for the current and new serving sectors by corresponding sector congestion level values, and comparing the weighted signal quality measurements.

7. The method of claim 6, wherein comparing the weighted signal quality measurements comprises determining if a difference between the weighted signal quality measurements of the current and new serving sectors exceeds a defined threshold.

8. The method of claim 7, wherein selectively changing from a current serving sector to a new serving sector comprises changing to the new serving sector if the difference exceeds the defined threshold.

9. The method of claim 7, wherein selectively changing from a current serving sector to a new serving sector comprises changing to the new serving sector according to one or more defined probability values if the difference exceeds the defined threshold.

10. The method of claim 9, further comprising receiving probability information from the network that determines the one or more defined probability values.

11. A mobile station comprising:
radio frequency transceiver circuits configured to send signals to a wireless communication network, and to receive signals from the wireless communication network; and
one or more processor circuits operatively associated with the radio frequency transceiver circuits and configured to select a serving sector from among a set of sectors in the network that are candidates for serving the mobile station on a forward link packet data channel based at least in part on receiving sector congestion information for one or more of the sectors in the set.

12. The mobile station of claim 11, further comprising at least temporarily excluding from selection consideration a designated one of the sectors in the set of sectors that are serving sector candidates for the mobile station responsive to a receiving a message identifying the designated sector.

13. The mobile station of claim 12, further comprising setting a time for which the designated sector is removed from selection consideration based on a value received in the message.

14. The mobile station of claim 11, wherein the mobile station is configured to select the serving sector by comparatively evaluating sector congestion information and sector signal quality for two or more of the sectors in the set.

15. The mobile station of claim 11, wherein the mobile station is configured to change from a current serving sector to a new serving sector responsive to determining that a combination of signal quality and sector congestion is more favorable in the new serving sector than in the current serving sector.

16. The mobile station of claim 11, wherein the mobile station is configured to change from a current serving sector to a new serving sector according to a defined probability value responsive to determining that a combination of signal quality and sector congestion is more favorable in the new serving sector than in the current serving sector.

17. The mobile station of claim 16, wherein the mobile station is configured to set the defined probability value based on receiving probability information from the network.

18. The mobile station of claim 11, wherein the mobile station is configured to change from a current serving sector to a new serving sector responsive to determining that a metric based on signal quality and sector congestion for the new serving sector is more favorable than for the current serving sector.

19. The mobile station of claim 11, wherein the mobile station is configured to at least temporarily exclude from selection consideration a designated one of the sectors in the set of sectors that are serving sector candidates for the mobile station responsive to a receiving a message identifying the designated sector.

20. The mobile station of claim 19, wherein the mobile station is configured to set a time for which the designated sector is removed from selection consideration based on a value received in the message.

21. A method of serving sector selection by a mobile station comprising:
receiving forward packet data service at the mobile station from a current serving sector that is in a set of sectors that are serving sector candidates;
receiving sector congestion information for one or more of the sectors in the set; computing signal quality measurements for one or more of the sectors in the set; and
determining whether to change from the current serving sector to a new serving sector based on evaluating the signal quality measurements and the sector congestion information.

22. The method of claim 21, wherein determining whether to change from the current serving sector to a new serving sector based on evaluating the signal quality measurements and the sector congestion information comprises determining that another sector has substantially the same or better signal quality than the current serving sector, and is less congested than the current serving sector.

23. The method of claim 21, wherein determining whether to change from the current serving sector to a new serving sector based on evaluating the signal quality measurements and the sector congestion information comprises determining that another sector has a better signal quality than the current serving sector, but is too congested to be selected as the new serving sector.

24. The method of claim 21, wherein determining whether to change from the current serving sector to a new serving sector based on evaluating the signal quality measurements and the sector congestion information comprises weighting signal quality measurements for the current serving sector and at least one other sector in the set by corresponding sector congestion level values, and selectively changing to the other sector as the new serving sector based on comparing the weighted signal quality measurements.

25. The method of claim 24, wherein selectively changing to the other sector as the new serving sector based on comparing the weighted signal quality measurements comprises changing to the other sector if the weighted signal quality measurement for the other sector is better than the weighted signal quality measurement for the current serving sector by a defined margin.

26. The method of claim 24, wherein selectively changing to the other sector as the new serving sector based on comparing the weighted signal quality measurements comprises changing to the other sector according to a defined probability value if the weighted signal quality measurement for the other sector is better than the weighted signal quality measurement for the current serving sector.

27. The method of claim 26, further comprising receiving probability information at the mobile station to set the defined probability value.

28. A method of providing mobile stations with sector congestion information for sectors in a wireless communication network comprising:
determining sector congestion information for each of one or more sectors providing a forward link packet data service that is autonomously selectable by mobile stations; and
transmitting the sector congestion information in each of the one or more sectors to facilitate sector selection by mobile stations engaged in the forward link packet data service.

29. The method of claim 28, wherein determining sector congestion information for each of one or more sectors providing a forward link packet data service that is autonomously selectable by mobile stations comprises, in each sector, estimating at least one of a forward link congestion level value and a reverse link congestion level value.

30. The method of claim 29, wherein, for each sector, estimating a forward link congestion level value comprises estimating resource availability for the forward link packet data service in the sector.

31. The method of claim 29, wherein, for each sector, estimating a forward link congestion level value comprises determining the number of mobile stations currently engaged in the forward link packet data service in the sector.

32. The method of claim 29, wherein, for each sector, estimating a forward link congestion level value comprises determining a forward link loading value based on at least one of the number of mobile stations being supported in the sector, the availability of transmitter power or coding resources in the sector, the average forward link sector throughput for the forward link packet data service, and the quality of service requirements associated with one or more of the mobile stations currently engaged in the forward link packet data service in the sector.

33. The method of claim 29, wherein, for each sector, estimating a reverse link congestion level value comprises determining a reverse link loading value based on estimating a rise-over-thermal value for a base station receiver in the sector.

34. The method of claim 28, wherein transmitting the sector congestion information, for each sector, comprises periodically transmitting the sector congestion information on a control channel signal transmitted in support of the forward link packet data service.

35. The method of claim 28, wherein transmitting the sector congestion information, for each sector, comprises determining whether a current congestion condition for the sector exceeds a defined congestion threshold, and, if so, periodically transmitting the sector congestion information on a control channel signal transmitted in support of the forward link packet data service.

36. The method of claim 28, wherein each sector provides the forward link packet data service based on transmitting a shared forward link packet data channel signal, and wherein transmitting the sector congestion information comprises transmitting the sector congestion information on a forward link packet data control channel signal that is transmitted in conjunction with the shared forward link packet data channel signal.

37. The method of claim 28, further comprising, transmitting a message to a particular mobile station indicating that it should at least temporarily exclude a specified sector from consideration as a candidate for serving sector selection by the mobile station.

38. A sectorized base station system comprising:
one or more congestion estimation circuits configured to estimate sector congestion information for each sector of the base station system, said sector congestion information comprising at least forward link sector congestion information; and
one or more transmitter circuits configured to transmit the sector congestion information in the corresponding sectors of the base station system.

39. The base station system of claim 38, wherein the base station system includes a radio base station, and wherein the one or more congestion estimation circuits and the one or more transmitter circuits comprise radio base station circuits.

40. The base station system of claim 38, wherein the base station system includes a base station controller and a radio base station, and wherein the one or more congestion estimation circuits comprise base station controller circuits and the one or more transmitter circuits comprise radio base station circuits.

41. The base station system of claim 38, wherein the base station system is configured to transmit a shared forward link packet data channel signal and an associated forward link packet data control channel signal in each sector of the base station system, and is further configured to provide the sector congestion information on the forward link packet data control channel signal being transmitted in each sector.

42. The base station system of claim 41, wherein the base station system is configured to transmit the sector congestion information periodically in each sector.

43. The base station system of claim 41, wherein the base station system is configured to transmit the sector congestion information on a per sector basis in each sector wherein one or more congestion metrics exceed one or more defined thresholds.

44. The base station system of claim 41, wherein the base station system is configured to provide packet data service using a Forward Packet Data Channel (F-PDCH), and is configured to provide sector congestion information via a corresponding Forward Packet Data Control Channel (F-PDCCH).

45. The base station system of claim 38, wherein the base station system is configured to transmit a message to a particular mobile station indicating that it should at least temporarily exclude a specified sector from consideration as a candidate for serving sector selection by the mobile station.

46. A method of influencing autonomous serving sector selection decisions made by mobile stations, the method comprising sending a message to a mobile station indicating that an identified one in a set of sectors considered as candidates for serving sector selection by the mobile station should be at least temporarily excluded from consideration by the mobile station.
